(19) United States
(12) Patent Application Publication
(10) Pub. No.: US 2007/0166664 A1
(43) Pub. Date: Jul. 19, 2007

(54) Dental cutter

(76) Inventors: Friedrich Wilhelm Meier, Blomberg (DE); Josef Hecke, Dorentrup (DE)

Correspondence Address: Bliss McGlynn, P.C., Suite 600, 2075 West Big Beaver Road, Troy, MI, 48084, US

(21) Appl. No.: 11/654,860

(22) Filed: Jan. 18, 2007

(30) Foreign Application Priority Data
Jan. 19, 2006 (DE) 10 2006 002 722.1

(51) Int. Cl. A61C 3/02

(52) U.S. Cl. 433/165

(57) ABSTRACT

A dental cutter includes a cutter head adapted for attachment to a shaft, the head being provided with a plurality of cutting edges, the cutter head including two cross-cuts which are respectively formed helically at the cutter head, wherein the two cross-cuts extend with an opposite twist.

### BACKGROUND OF THE INVENTION

1. Field of the Invention

The present invention relates generally to dental cutters and, more specifically, to a dental cutter which can be used, for example, for metal alloys which are hard to machine, such as cobalt chromium alloys, for example, for the manufacturing of crowns, bridges and/or partial implants.

2. Description of the Related Art

Known dental cutters feature different types of toothings. The term “toothing” in the context of this application refers to the arrangement and shape of the individual cutting edges. The cutting head of the dental cutter thus includes a plurality of cutting edges. According to the state of the art, the cutting edges may also be provided with a cross-cut which intercepts the cutting edge with an incision. Consequently, there result smaller chips when machining long-chipping materials.

### SUMMARY OF THE INVENTION

It is an object of the present invention to provide a dental cutter of the aforementioned kind, which exhibits a high removal performance while having a simple structure and being manufactured in a simple and cost-effective way.

According to the present invention, the object is solved by the combination of features of the present invention.

According to the present invention, the dental cutter includes two cross-cuts which extend respectively helical at the cutter head, wherein the two cross-cuts extend with an opposite twist. Consequently, the helical direction or the twist of the two cross-cuts differ from each other. One of the two cross-cuts extends clockwise, whereas the other cross-cut is formed counter-clockwise.

Due to the inventive embodiment, segments of cutting edges with different widths are obtained, as the individual cutting edges are divided by the cross-cuts into cutting edge portions of different lengths. With this embodiment, an increased removal performance is achieved, as chips of different sizes are generated when machining a material. In addition to the increased removal performance, the dental cutter also exhibits an increased service life.

In a particularly advantageous further development of the present invention, the two cross-cuts extend helically, i.e. with a constant pitch, along the cutter head. Therewith, a constant arrangement of different lengths of cutting edge portions along the complete length of the cutter head is achieved.

The two cross-cuts may, according to the present invention, be formed either with an equal pitch or with a differing pitch. Therewith, cutting edge geometries can be obtained, which can be optimized for specific materials.

According to the present invention, it may also be advantageous if a helical cross-cut is respectively provided. This means that a clockwise cross-cut and a counter-clockwise cross-cut are formed at the cutter head. In another embodiment, it is also possible to provide a plurality of cross-cuts being parallel to one another, such that e.g. two cross-cuts are formed to extend parallel to each other and clockwise, whereas two further cross-cuts are formed to extend in parallel and counter-clockwise. It should be appreciated that a larger number of parallel cross-cuts can be provided.

In the inventive cutter head, it is possible to interlock the cutting edges straight or to provide same with a right-hand twist or a left-hand twist.

With respect to the embodiment of the cutter head, the present invention is not limited to specific shapes. It is rather possible to form the cutter head cone-shaped or spherical.

Other objects, features, and advantages of the present invention will be readily appreciated, as the same becomes better understood, after reading the subsequent description taken in conjunction with the accompanying drawings.

### BRIEF DESCRIPTION OF THE DRAWINGS

In the following, the present invention is described on the basis of an example in combination with the drawing, in which:

FIG. 1 is an illustration of a cutter head according to the invention.

### DESCRIPTION OF THE PREFERRED EMBODIMENT(S)

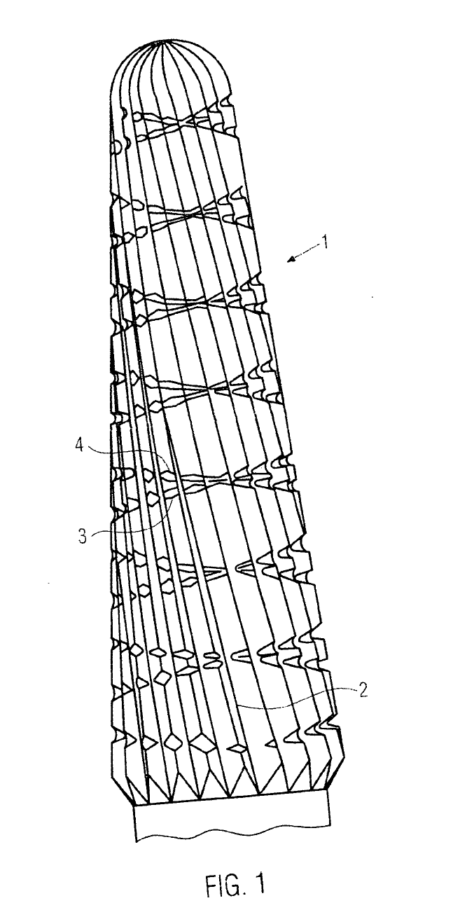

Referring now to the drawings, and in particular FIG. 1, one embodiment of a dental cutter, according to the present invention, is shown. FIG. 1 shows a cutter head 1 attached to a shaft, which is provided with a plurality of cutting edges 2 being parallel to each other. The cutter head 1 is formed substantially cone-shaped. With respect to the embodiment of the cutter head 1, the present invention is not limited to specific shapes. It is rather possible to form the cutter head 1 cone-shaped, cylindrical, or spherical.

In addition to the cutting edges 2, the cutter head 1 includes a plurality of cross-cuts being parallel to one another, such that e.g. two cross-cuts are formed to extend parallel to each other and clockwise, whereas two further cross-cuts are formed to extend in parallel and counter-clockwise. It should be appreciated that a larger number of parallel cross-cuts can be provided.

In the embodiment illustrated, the cutter head 1 includes a first cross-cut 3 and a second cross-cut 4, which extend helically around the cutter head 1. The cross-cuts 3,4 are formed with an opposite direction of helix or with an opposite twist. In one embodiment, the helical direction or the twist of the two cross-cuts 3,4 differ from each other. One of the two cross-cuts 3,4 extends clockwise, whereas the other cross-cut is formed counter-clockwise. The two cross-cuts 3,4 may, according to the present invention, be formed either with an equal pitch or with a differing pitch.

From FIG. 1, it can be seen that the cutting edges 2 are respectively divided into cutting edge portions of different lengths. It should be appreciated that it is possible to interlock the cutting edges 2 straight or to provide the same with a right-hand twist or a left-hand twist.

Upon a rotation of the cutter head 1, there result continuously different, respectively engaging cutting edge lengths, which respectively produce a different chip width or chip length. Therewith, the chip removal performance increases considerably.

The present invention has been described in an illustrative manner. It is to be understood that the terminology, which has been used, is intended to be in the nature of words of description rather than of limitation.

Many modifications and variations of the present invention are possible in light of the above teachings. Therefore, within the scope of the appended claims, the present invention may be practiced other than as specifically described.

What is claimed is:

1. A dental cutter comprising:
a cutter head adapted for attachment to a shaft, said cutter head being provided with a plurality of cutting edges;
said cutter head comprising two cross-cuts which are respectively formed helically at said cutter head, wherein said two cross-cuts extend with an opposite twist.

2. A dental cutter as set forth in claim 1 wherein said two cross-cuts extend helically.

3. A dental cutter as set forth in claim 1 wherein said two cross-cuts are formed with an equal pitch.

4. A dental cutter as set forth in claim 1 wherein said two cross-cuts are formed with a differing pitch.

5. A dental cutter as set forth in claim 1 including a helical cross-cut in said cutter head.

6. A dental cutter as set forth in claim 1 including a plurality of cross-cuts being parallel to each other.

7. A dental cutter as set forth in claim 1 wherein said cutting edges are interlocked straight.

8. A dental cutter as set forth in claim 1 wherein said cutting edges are interlocked with a right-hand twist.

9. A dental cutter as set forth in claim 1 wherein said cutting edges are interlocked with a left-hand twist.

10. A dental cutter as set forth in claim 1 wherein said cutter head is cone-shaped.

11. A dental cutter as set forth in claim 1 wherein said cutter head is spherical.

12. A dental cutter as set forth in claim 1 wherein said cutter head is cylindrical.

13. A dental cutter comprising:
a shaft;
a cutter head attached to said shaft, said cutter head being provided with a plurality of cutting edges (2);
said cutter head comprising a plurality of cross-cuts which are respectively formed helically at said cutter head, wherein said cross-cuts extend with an opposite twist.
